(19) United States
(12) Patent Application Publication
(10) Pub. No.: US 2014/0218604 A1
(43) Pub. Date: Aug. 7, 2014

(54) ELECTRONIC DEVICE AND IMAGE CAPTURING METHOD

(71) Applicant: HON HAI PRECISION INDUSTRY CO., LTD., New Taipei (TW)

(72) Inventors: SHU-MING LIU, New Taipei (TW); CHIA-JUNG LIU, New Taipei (TW); YI-RU LAI, New Taipei (TW)

(73) Assignee: HON HAI PRECISION INDUSTRY CO., LTD., New Taipei (TW)

(21) Appl. No.: 14/161,642

(22) Filed: Jan. 22, 2014

(30) Foreign Application Priority Data
Feb. 4, 2013 (TW) 102104261

(51) Int. Cl. H04N 5/225

(52) U.S. Cl. CPC H04N 5/2251
USPC 348/373

(57) ABSTRACT

An electronic device includes a front panel, a display located on the front panel, a rear panel opposite to the front panel, a camera lens located on at least one of the front panel and the rear panel, a side flange connected between the front panel and the rear panel, and a touch strip is located on the side flange. The touch panel is configured to receive a control operation to adjust an image capturing function.

### BACKGROUND

The disclosed embodiments relate generally to an electronic device and a image capturing method.

2. Description of Related Art

A digital camera encodes images and videos digitally and stores them for later use. Some smart devices, such as smart phones, tablet computers are equipped with cameras for capturing images as needed. These kinds of image capturing electronic devices usually include two control buttons, such as volume buttons or a scroll wheel, to manually adjust a control function, such as focal length, or shutter speed, when capturing the image. However, the control buttons and the scroll wheel protrude from a body of the electronic device and uses space inside the electronic device. There is need for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a front view of an electronic device in one embodiment.

FIG. 2 is bottom view of the electronic device of FIG. 1.

FIG. 3 is rear view of the electronic device of FIG. 1.

FIG. 4 is a block view of the electronic device of FIG. 1.

FIG. 5 is an image capturing view of the electronic device of FIG. 1.

FIG. 6 is similar to FIG. 2, but shown a slide operation on a touch strip.

FIG. 7 is similar to FIG. 5, but an image capturing function is adjusted.

FIG. 8 is similar to FIG. 5, but the electronic device is operated by one hand.

FIG. 9 is a block view of an image capturing method in one embodiment.

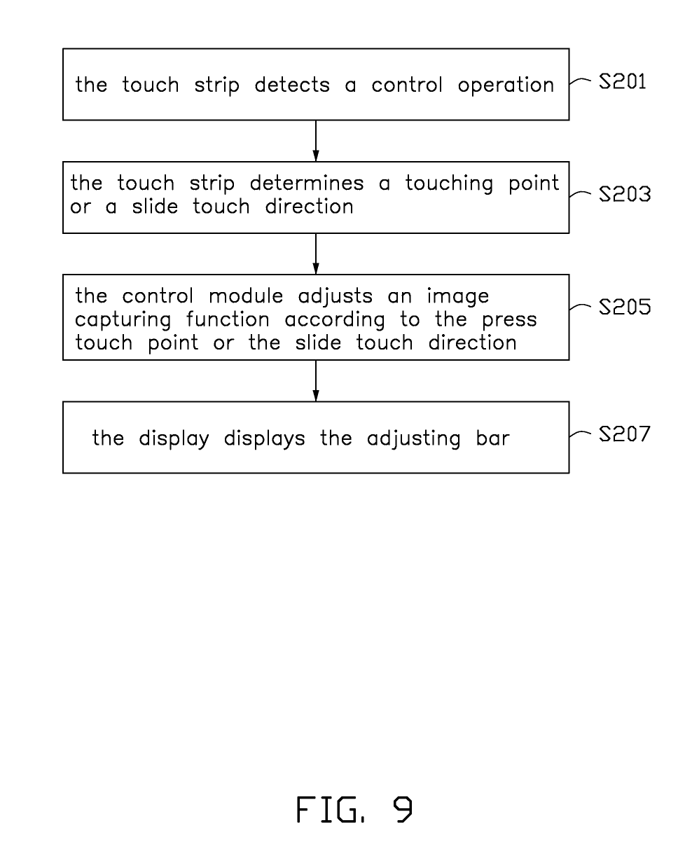

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

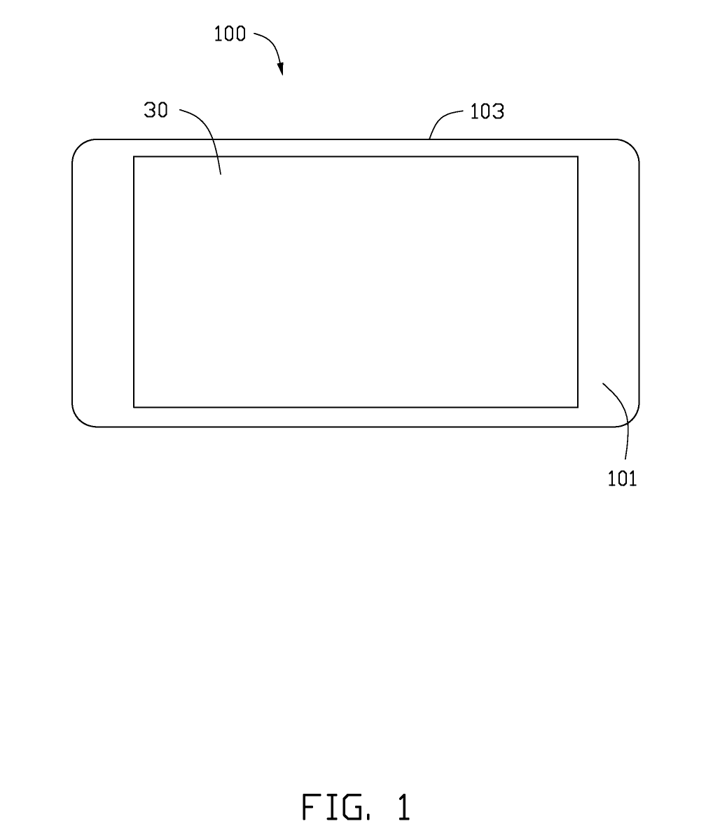

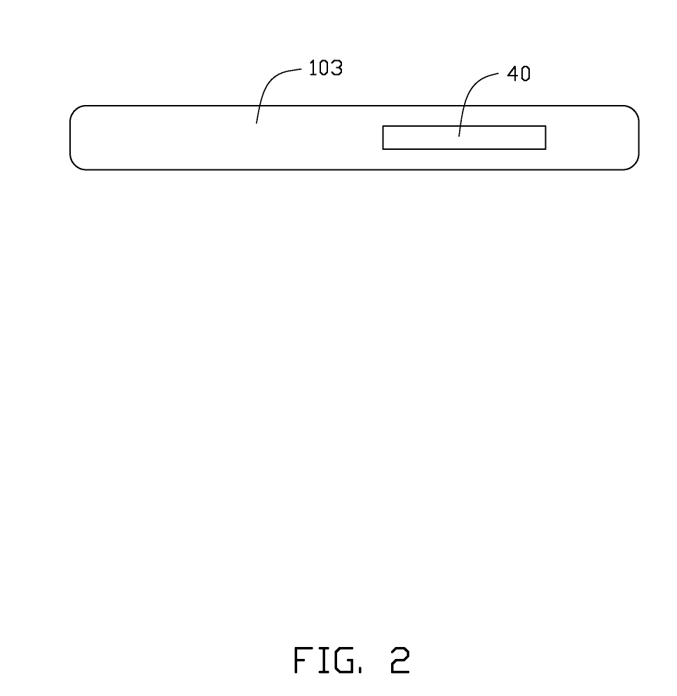

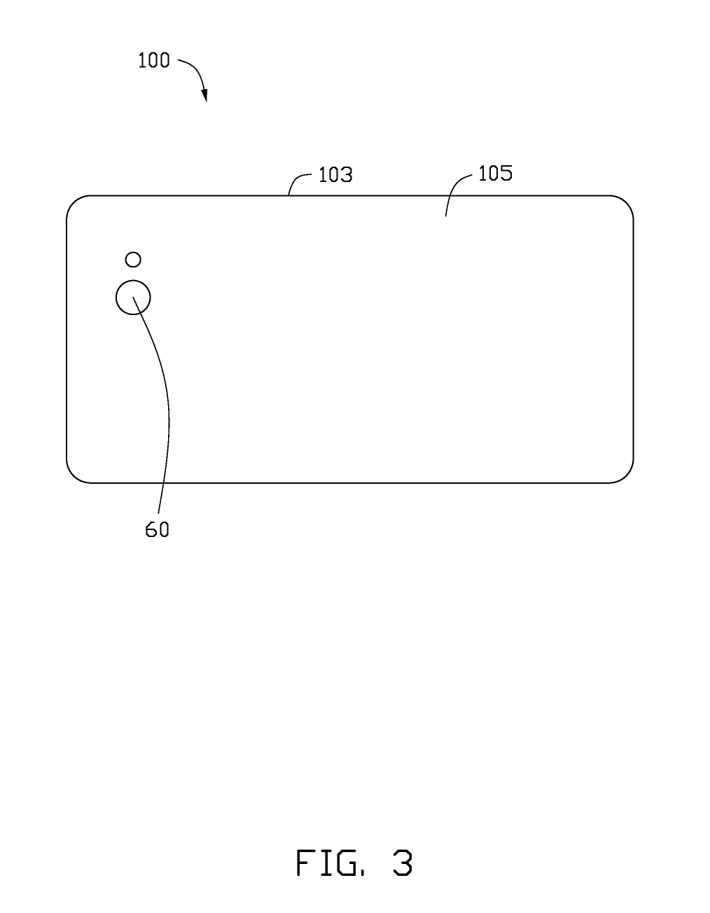

FIGS. 1 to 3 are different views of an electronic device 100 from different aspects of one embodiment. The electronic device 100 may be a digital camera, a smart phone, or a tablet computer. The electronic device 100 includes a front panel 101, a rear panel 105, a side flange 103 located between the front panel 101 and the rear panel 105. The front panel 101 is substantially parallel to the rear panel 105. The electronic device 100 may be flat formed. The side flange 103 can be a plane surface, or a smooth curved surface. The side flange 103 connects the front panel 101 and the rear panel 105, and is substantially perpendicular to the front panel 101 and the rear panel 105 when the side flange 103 is flat.

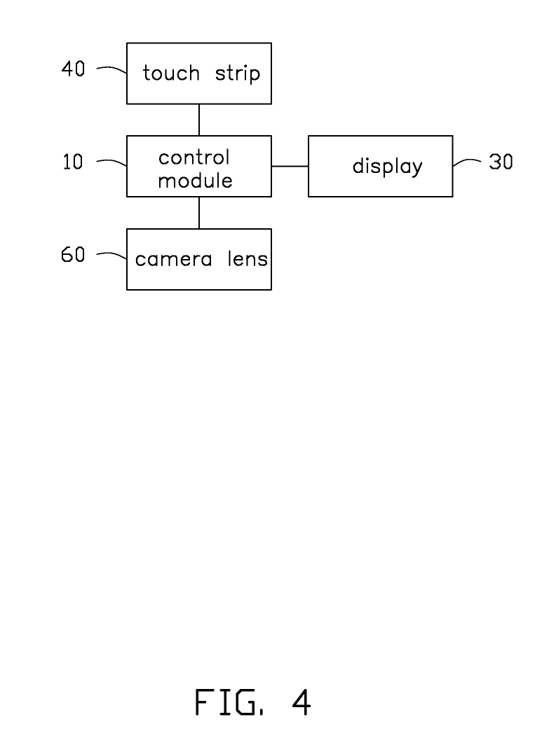

FIG. 4 illustrates a block view of the electronic device 100. The electronic device 100 further includes a display 30 located on the front panel 101, a touch strip 40 located on the side flange 103, a camera lens 60, and a control module 10. The display 30, the touch strip 40 and the camera lens 60 are all electronically connected to the control module 10. The display 30 may be a touch sensitive screen. The camera lens 60 may be located on at least one of the front panel 10 or the rear panel 105. The touch strip 40 is substantially linear, and is a touch panel and made from carbon nanotubes. The touch strip 40 can receive slide operation or press operation to control the image capturing operation, such as adjusting focal length, white balance, or shutter speed, for example. The control module 10 is a processor to control input signals from the touch strip 40.

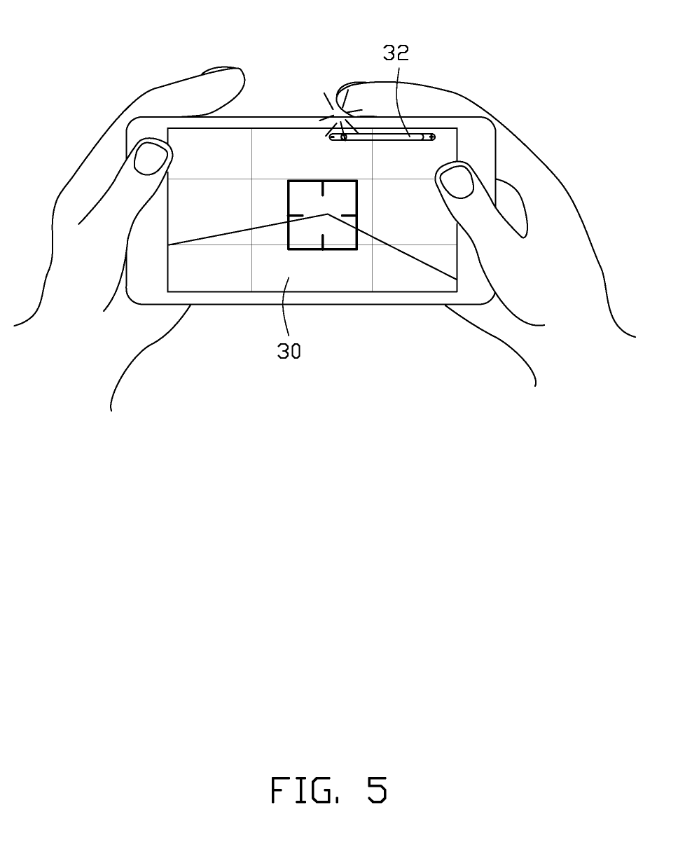

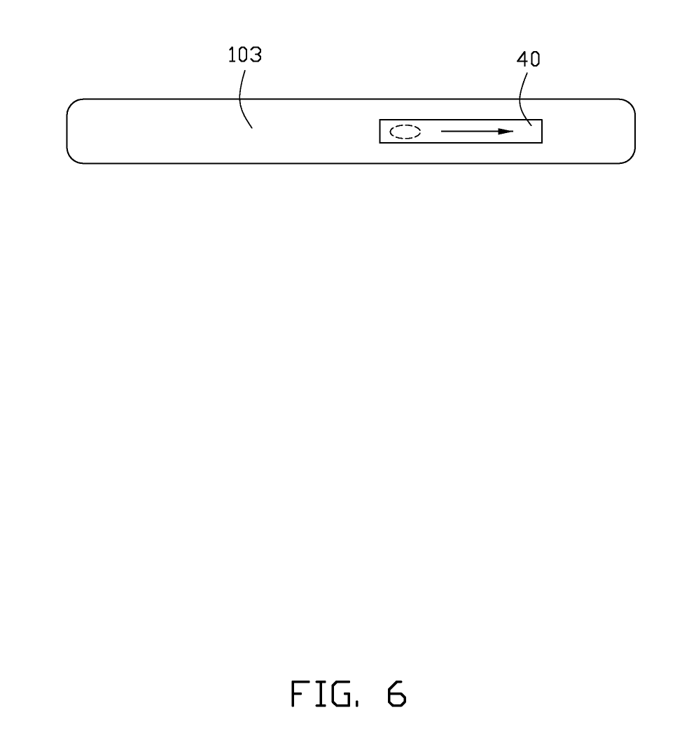

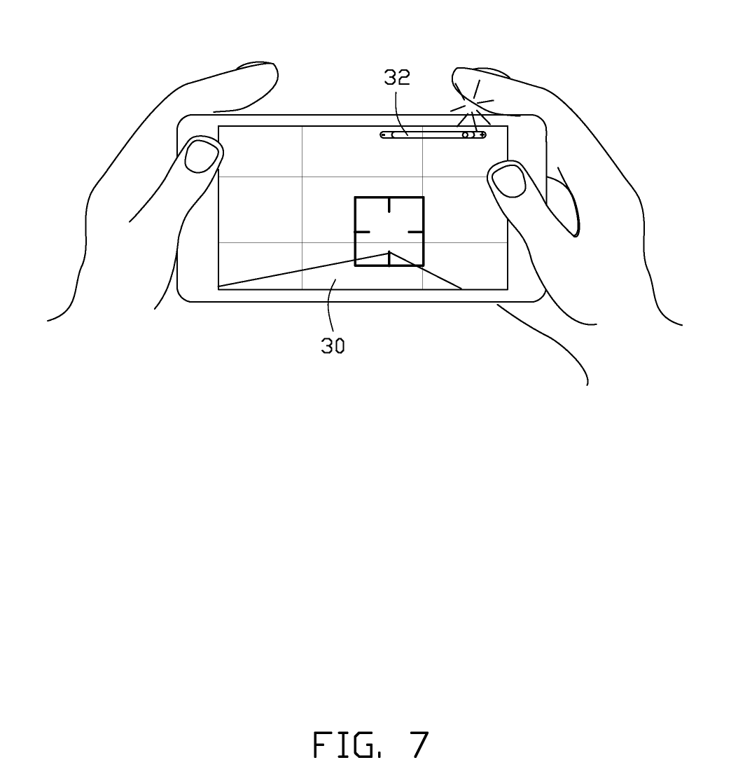

FIGS. 5 to 7 illustrate a working state of the electronic device 100 from three aspects. In use, the electronic device 100 enters into an image capturing state, when adjusting a focal length, the touch strip 40 detects a press operation or a slide operation. A control module 10 controls a image capturing view in the display 30 according to the operation on the touch strip 40. For example, when the touch strip 40 detects a slide operation from left to right, the image capturing view is to zoom in. An adjusting bar 32 can be further displayed on a user interface of the display 30 to couple to the touch strip 40. A location of the adjusting bar 32 on the display 30 corresponds to a location of the touch strip 40. A length of the adjusting bar 32 is substantially equal to a length of the touch strip 40. When the touch strip 40 detects a press operation, the adjusting bar 32 is dynamically adjusted according to a press point of the touch strip 40.

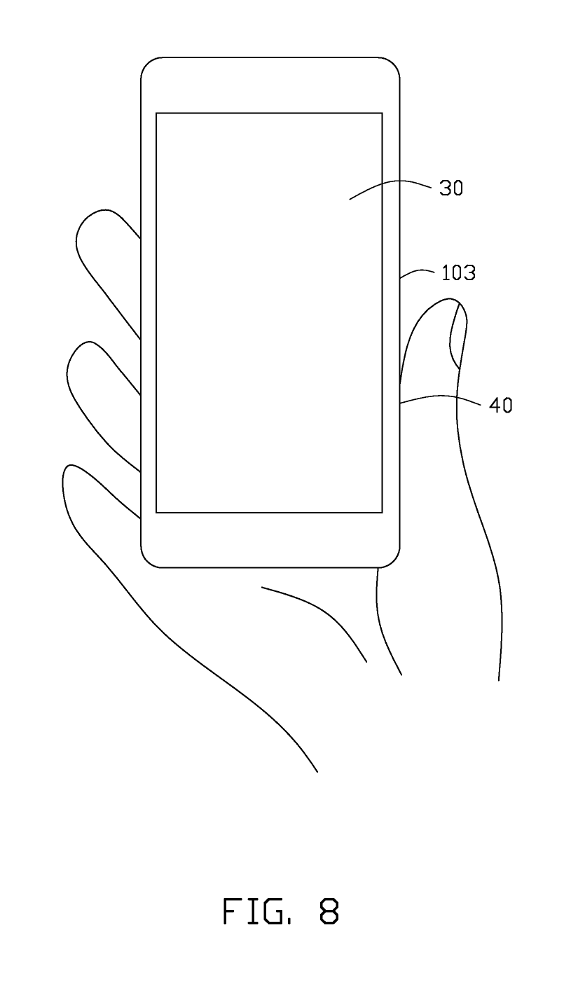

FIG. 8 illustrates the electronic device 100 in one hand. When an image capturing operation is adjusted through the touch strip 40, only one hand is needed.

An image capturing method for the electronic device includes the following steps.

Steps S201: the touch strip 40 detects a control operation.

Steps S203: the touch strip 40 determines a touching point or a slide touch direction.

Steps S205: the control module adjusts an image capturing function according to the press touch point or the slide touch direction.

Steps S207: the display 30 displays the adjusting bar 32. The adjusting bar 32 is dynamically adjusted according to the press touch point of the touch strip 40.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

Depending on the embodiment, certain steps or methods described may be removed, others may be added, and the sequence of steps may be altered. It is also to be understood that the description and the claims drawn for or in relation to a method may include some indication in reference to certain steps. However, any indication used is only to be viewed for identification purposes and not as a suggestion as to an order for the steps.

What is claimed is:

1. An electronic device, comprising:
a front panel;
a display located on the front panel;
a rear panel opposite to the front panel;
a camera lens located on at least one of the front panel and the rear panel;
a side flange connected between the front panel and the rear panel; and
a touch strip located on the side flange;
wherein the touch panel is configured to receive a control operation to adjust a image capturing function.

2. The electronic device of claim 1, wherein the side flange comprises a flat surface.

3. The electronic device of claim 1, wherein the side flange comprises a smooth curved surface.

4. The electronic device of claim 1, wherein the front panel is substantially parallel to the rear panel, and the side flange is substantially perpendicular to the front panel and the rear panel.

5. The electronic device of claim 1, wherein the touch strip is a touch panel.

6. The electronic device of claim 1, wherein the touch strip is configured to receive a slide operation.

7. The electronic device of claim 1, wherein the touch strip has a linear configuration.

8. The electronic device of claim 1, wherein the touch strip is formed from carbon nanotubes.

9. The electronic device of claim 1, wherein the touch strip is configured to adjust a focal length when photographing.

10. An image capturing method, comprising:
providing an electronic device, comprising:
a front panel;
a display located on the front panel;
a rear panel opposite to the front panel;
a camera lens located on at least one of the front panel and the rear panel;
a side flange connected between the front panel and the rear panel; and
a touch strip located on the side flange;
detecting an control operation on the touch strip; and
adjusting an image capturing function according to the control operation.

11. The image capturing method of claim 10, wherein the side flange comprises a flat surface.

12. The image capturing method of claim 10, wherein the side flange comprises a smooth curved surface.

13. The image capturing method of claim 10, wherein the front panel is substantially parallel to the rear panel, and the side flange is substantially perpendicular to the front panel and the rear panel.

14. The image capturing method of claim 10, wherein the touch strip is a touch panel.

15. The image capturing method of claim 10, wherein the touch strip is configured to receive a slide operation.

16. The image capturing method of claim 10, wherein the touch strip has a linear configuration.

17. The image capturing method of claim 10, wherein the touch strip is formed from carbon nanotubes.

18. The image capturing method of claim 10, wherein adjusting the image capturing function according to the control operation further comprises adjusting a focal length.

19. The image capturing method of claim 18, further comprising: displaying an adjusting bar on the display, wherein a location of the adjusting bar corresponds to the touch strip, and a length of the adjusting bar is substantially equals to a length of the touch strip.

20. The image capturing method of claim 19, further comprising: pressing the touch strip to adjusting the focal length, wherein the adjusting bar is dynamically adjusted according to a touch point of the touch strip.
